(19) United States
(12) Patent Application Publication
(10) Pub. No.: US 2017/0318832 A1
(43) Pub. Date: Nov. 9, 2017

(54) Frozen Tea Treat with Non-Synthetic Ingredients and Method of Making the Same

(71) Applicants: Dionne Laslo-Baker, Victoria (CA); Joahua Baker, Victoria (CA); David Baker, Victoria (CA)

(72) Inventors: Dionne Laslo-Baker, Victoria (CA); Joahua Baker, Victoria (CA); David Baker, Victoria (CA)

(21) Appl. No.: 15/147,540

(22) Filed: May 5, 2016

(51) Int. Cl. A23G 9/42; A23F 3/40; A23G 9/34

(52) U.S. Cl. CPC A23G 9/42; A23G 9/34; A23F 3/40; A23V 2002/00

(57) ABSTRACT

The invention relates to ice lollys comprising a frozen liquid tea based composition comprising: water, tea powder or tea concentrate, methyl glucoside coconut oil ester, guar, gellan or pectin gum, and USDA certified organic non-genetically modified organism (non-GMO) grown fruit or vegetables in the form of a concentrate of liquid, puree, or powder. The processing and subsequent packaging allows the composition to be processed without heating and/or pasteurization but remain shelf stable in the frozen form.

### PRIORITY

This application claims priority under 35 USC 119 from Provisional Application Number 62/157,822 entitled “Frozen Tea Treat with Non-Synthetic Ingredients and Method of Making the Same”, filed May 6, 2015.

### FIELD OF THE DISCLOSURE

The present disclosure relates to the field of frozen foods and associated treats using only non-synthetic and primarily non-processed foods and food additives. More specifically, the present disclosure relates to ice lollys composed primarily of tea with the addition of nutrients such as minerals and vitamins existing in powders, purees or liquid concentrates of fruits and/or vegetables which are combined and frozen, allowing for shelf stability and portability as well as a method for processing and packaging the same without the use of heat and/or pasteurization.

### BACKGROUND

The statements in this section merely provide background information related to the present disclosure and are not provided to constitute prior art.

Iced lollys are a common type of frozen treat. The ice lolly, however, is not typically an option for health conscious consumers, as it is often prepared with ingredients that include processed and often unhealthy sugars and fats. Ice lollys are sold frozen, and therefore, are also subject to melting if not timely stored in the frozen state.

In addition, the ice lolly, while it may be soothing for the consumer, is often not nourishing. Often times, people undergoing medical procedures are patients unable to eat food or drink liquids normally either before or after undergoing a particular medical procedure. Nevertheless, patients need to remain hydrated and nourished. Patients may be given primarily sugar water with synthetic or even “natural” flavoring to provide hydration, but such ice lollys have little or no nutritional value components, and therefore do not provide the source of nourishment desired.

This and other issues are especially prevalent in today's North American culture and often the children of many North Americans are subjected to these improper frozen “treats” as an alternative to those which parents would rather provide. The compromise often occurs due to the need for convenience as well as the need for having a shelf stable product which can be acquired within a moments' notice. Health conscious consumers, as well as healthcare facilities (and their patients), now increasingly desire alternative delivery systems for vitamins and nutrient rich ingredients. Indeed, several consumer products exist on the market that infuse such nourishing aspects into their products that, by themselves have, little if any nutritional value, such as water and gum.

However, there are no primarily tea based iced products, composed of non-synthetic ingredients, that offer healthy tea based frozen ice lollys for convenience to health conscious consumers, and no such product for those undergoing medical procedures or otherwise struggling with health issues. The use of tea instead of (mostly pure) water as a primary base for these products is a critical part of the invention described herein. Regarded for thousands of years in Asian countries as a key to good health, happiness, and wisdom, tea has caught the attention of researchers in the West, who are continually discovering the many health benefits of different types of teas.

Studies have found that some teas may help with cancer, heart disease, and diabetes; encourage weight loss; lower cholesterol; and bring about mental alertness. Tea also is known to possess antimicrobial qualities.

The American Dietetic Association states that natural teas have less caffeine than coffee and it has been established that the compounds in tea—flavonoids—are good for the heart and may reduce the risk of certain cancers. Although a lot of questions remain about steeping for the most benefit or how much you need to drink, nutritionists agree that essentially any tea is healthful tea.

Tea is a name given to a lot of brews, but purists consider only green tea, black tea, white tea, oolong tea, and pu-erh (Pu'er) tea as actual teas. These tea leaves are all derived from the Camellia sinensis plant, a shrub native to China and India, and contains the unique antioxidants known as flavonoids. The most potent of these, known as ECGC, which is Epigallocatechin gallate (EGCG), also known as epigallocatechin-3-gallate, which is the ester of epigallocatechin and gallic acid, and is a type of catechin that helps quench free radicals that can contribute to cancer, heart disease, and clogged arteries. All these teas also contain caffeine and theanine, which positively affect the human brain and seem to heighten mental alertness.

The more processed the tea leaves, usually the lower the polyphenol content. These polyphenols include flavonoids. Oolong and black teas are more highly oxidized or fermented leading to lower concentrations of polyphenols than green tea.

As stated above, among all tea polyphenols, epigallocatechin-3-gallate has been shown to be responsible for much of the health promoting abilities of tea including anti-inflammatory, antimicrobial, anti-tumor, and anti-oxidative properties. The antibacterial, antiviral, and antifungal activities of different types of tea and their polyphenols allow for the composition of the present invention to be manufactured without the use of (often toxic) preservatives or antibacterial agents and to be processed while cold (preferably at or below 4 degrees centigrade) without the use of heating and/or pasteurization. There is a synergistic effect of tea polyphenols in combination with conventional antimicrobial agents that are effective against clinical multidrug-resistant microorganisms, which is another purpose for using teas as the basis for the compositions of the present invention. It has been found during the development of these compositions, and in contrast to what others have earlier realized and reported is that the existence of bacteria and inconsistency of the teas is inherent in the steeping process. For this and other reasons which will become apparent in the present disclosure, the frozen compositions do not employ tea processing using steeping. In some cases, the fruit and/or vegetables may be flash pasteurized prior to being used as an additive to the compositions of the present disclosure. The compositions described herein are mixtures.

The compositions (mixtures) herein have recently been developed with rooibos tea which in this case is added as a powder which initially was brewed (steeped) and then evaporated using spray drying techniques in order to not further reduce the natural inherent enzymatic activity and nature of the rooibos plant leaves. The powder is subsequently mixed with water and no solid residue is evident when this process takes place in providing the compositions of the present disclosure.

Health benefits of red rooibos tea include its use as a cure for nagging headaches, insomnia, asthma, eczema, bone weakness, hypertension, allergies, and premature aging. The tea is absolutely free from caffeine content and is also low in tannins. Drinking rooibos tea can further ease severe stomach cramps, as well as bring relief to asthma and other related conditions. It also boosts the immune system of the human body. Rooibos tea or red tea is a medicinal, herbal beverage that is acquired from the Aspalathus linearis bush plant that is found in South Africa. According to the South African Rooibos Council, rooibos is not a true tea, but an herb. The fermented tea is red in color. The rooibos plant grows naturally without any caffeine. This is important, as it means it does not need to undergo a chemical process to remove the caffeine. The other key benefit of no caffeine is that rooibos tea can be consumed in unrestricted amounts.

Rooibos tea also contains a wide array of antioxidants, which help to protect the body in a number of ways. Two polyphenol antioxidants known as aspalathin and nothofagin are found in high concentrations in rooibos tea. These antioxidants protect the immune system by quenching free radicals. These polyphenols also have anti-inflammatory properties and can safeguard against heart disease. Some studies have demonstrated a link between consumption of rooibos tea and a reduction of cancer-causing chemicals. This is because of the high level of dominant antioxidants, some of which have anti-mutagenic (anti-cancer) properties.

Another of the key health benefits of rooibos tea is that it contains several minerals that are vital to health. These include: magnesium (essential for the nervous system), calcium & manganese (essential for strong teeth and bones), zinc (important for metabolism) and iron (critical for helping blood & muscles distribute oxygen). One of the many potent antioxidants in rooibos tea is known as Chysoeriol. It can improve circulation by preventing the activity of the enzyme that triggers cardiovascular disease. Drinking of rooibos tea also has been known to lower blood pressure and cholesterol.

As rooibos tea contains high levels of flavonoids, one particular flavonoid known as quercetin has the ability to relieve numerous abdominal ailments such as cramps, diarrhea and indigestion. Flavonoids are known help to reduce spasm, inflammation and allergies. It has also been widely stated that the health benefits of rooibos tea extend to alleviating colic in babies—and as it is totally caffeine free, it is perfectly safe for them to drink rooibos tea.

Unlike most black teas, which prevent the body from absorbing iron effectively because of the tannins they contain, rooibos tea supports the body in absorbing iron. Rooibos tea contains less than half the tannins of black tea. A recent study found that rooibos tea contains phenylpyretic acid, which can help to improve acne, psoriasis and eczema. Drinking rooibos tea regularly can protect against a process known as lipid peridoxation. This occurs when free radicals damage brain cells and nerve tissue. If this is prolonged, it can lead eventually to progressive and deteriorating brain disease, such as Alzheimer's. Again, rooibos tea is unique in that it can be consumed often due to its lack of caffeine and is therefore known to help people to feel calm and relaxed. Together with the use of coconut palm ester(s) as the source for additional sweetening, the compositional mixtures of the present disclosure provide a frozen treat which is extremely nutritious, does not spike blood sugar levels, and does not provide caffeine so that it can be enjoyed at any time of the day or night without sleep deprivation issues. The “Dee Bees Frozen ice lolly” treats are the first certified Non-GMO, organic, kosher, vegan, tea-based treats that are gluten, dairy, nut, and soy free. These were developed to provide an option in place of high levels of sugar in frozen treats or other low-nutrient using other than whole food snacks.

### SUMMARY

The present invention solves a need in the frozen food industry by mixing together a variety of ingredients in a tea based formulation to form frozen compositions.

In a one embodiment what is provided is a frozen liquid tea based composition comprising: water, non-genetically modified organism (non-GMO) grown tea powder or tea concentrate, methyl glucoside coconut oil ester, guar, gellan or pectin gum, and USDA certified organic non-genetically modified organism (non-GMO) grown fruit or vegetables in the form of a concentrate of liquid, puree, or powder.

In another embodiment, a method of forming a frozen liquid composition, wherein the composition is water, tea powder or tea concentrate, methyl glucoside coconut oil ester, guar, gellan or pectin gum, and USDA certified organic non-genetically modified organism (GMO) grown fruits or vegetables in the form of a concentrate of liquid, puree, or powder comprising the steps of:
mixing the ingredients of said composition into a homogeneous mixture within a mixing device kept at or below 4 degrees Centigrade thereby keeping said mixture at or below 4 degrees Centigrade while filling and mixing said mixture into a container;
(ii) removing said mixture from said container after said mixture is homogeneous;
(iii) filling a cavity with said mixture while maintaining said mixture at or below 4 degrees Centigrade;
(iv) continuously cooling said mixture and;
(v) freezing said mixture within said cavity.

Another advantage of the present invention is that it provides a healthful USDA certified organic, kosher, non-genetically modified (non-GMO) grown alternative to frozen treats that conventionally contain high levels of processed sugars, fruits, and vegetables which are processed with heat or pasteurization. The process also allows for convenient delivery to health conscious consumers. The use of cold processing (at or below 4 degrees Centigrade throughout the processing cycle) improves the enzymatic activity of any of the fruits and vegetable powders, purees, and liquid concentrates used when compared to that of heated processes. This processing technique also allows for manufacture of the compositions of the present disclosure without the need for preservatives or antimicrobial/antibacterial additives.

Another advantage is that it may be sold in distinct flavors and sold in a shelf-stable frozen liquid form.

The details of one or more embodiments of the invention are set forth in the accompanying drawings and description below. The list of advantages above is not intended to be exhaustive. Other objects, features, and advantages of the invention will be apparent from the description and drawings, and from the claims.

### DESCRIPTION OF THE DRAWINGS

FIG. 1 is a product flow chart describing the process for manufacturing the tea based composition ice lollys according to one embodiment of the present invention.

### DETAILED DESCRIPTION

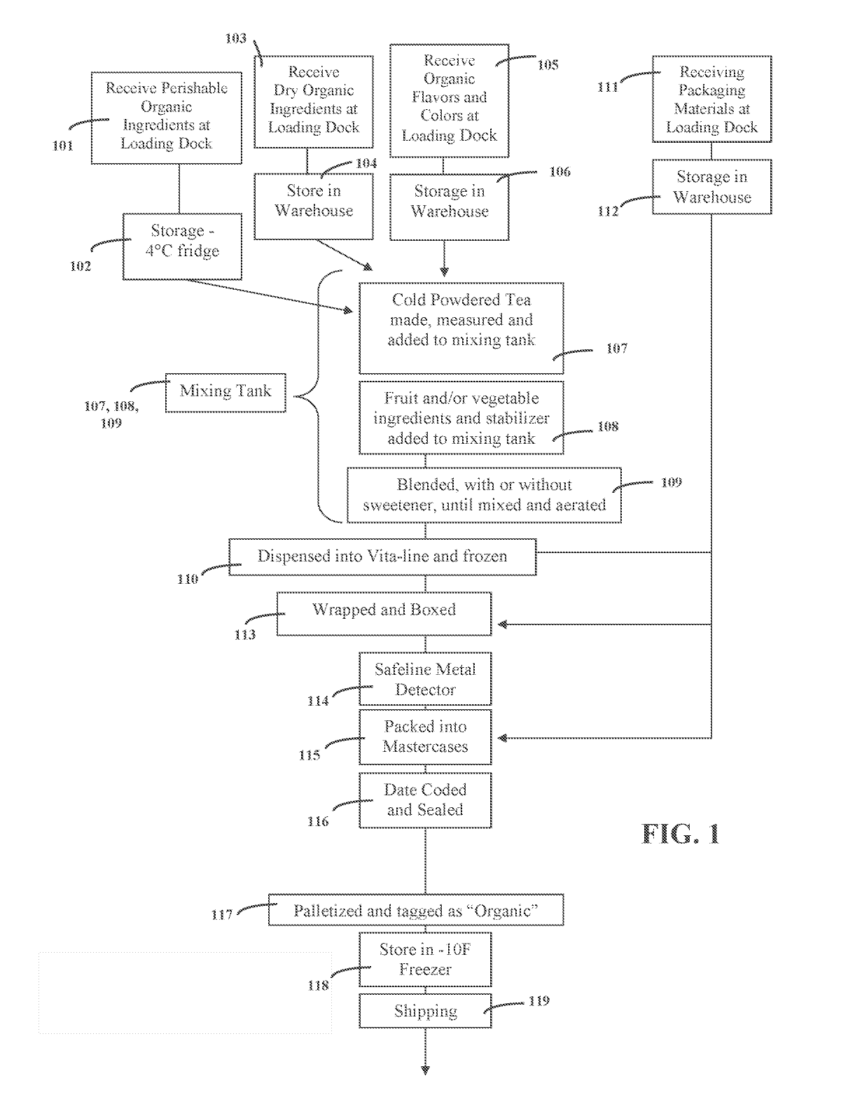

The present invention relates to preparing liquid tea-based compositions for processing frozen ice lollys comprising certified USDA organic, kosher, non-GMO fruit and vegetable ingredients and apparatus for packaging the same. Further explanation and variations of the present invention are described below with reference to FIG. 1.

FIG. 1 is a flowchart that describes the method of processing the tea-based ice lolly compositions of the present disclosure according to at least one embodiment of the present invention. To begin the process, perishable non-GMO, USDA certified organic, kosher ingredients are delivered (101) to the loading dock and stored at or below 4 degrees Centigrade in a refrigerated container (102). Also received (103) are dry organic non-GMO ingredients that are stored in an air-conditioned warehouse (104). Further, organic flavors and colors (if any) are also received at the loading dock (105) and stored in the same warehouse (104) as the dry ingredients. Next (107), the necessary and required amounts of cold powdered tea is measured and prepared by mixing in purified preconditioned water which can be accomplished by any one of a number of conventional means including reverse osmosis, distillation, deionization, filtration, etc. for adding to the mixing tank (107, 108, and 109). Also subsequently measured and added in the necessary and required amounts are the fruit (and/or vegetables), (108) as well as a stabilizer such as the organic guar gum into the mixing tank once the tea has reached homogeneous conditions. In this case, homogeneity is measured by the absence of any remaining solids or particles measured or seen visibly. This ensures the tea is providing its full set of attributes and properties as described in detail above. Finally, the ingredients are blended with or without the sweetener(s), specifically coconut palm nectar (coconut sugar), in the mixing tank (107,108,109) and mixed for the appropriate time at or below 4 degrees Centigrade. For emphasis, the entire process is performed at or below 4 degrees Centigrade prior to freezing to ensure non bacterial contamination of the composition before, during and after mixing. The preferred sweetener of choice is known by its latin name “cocos nucifer” which is certified organic tree sap that has been prepared by taking the sap of the coconut tree inflorescence (coconut fruits are not used for the manufacturing of this product) and the sap is evaporated until it turns into fine granules. The nutritional analysis of this sweetener which is manufactured and distributed through Sunopta which can be found at the following internet website address: www. sunopta.com and tradinorganic, which can be found at the following internet website address, www.tradinorganic.com, is as follows:

| | |
|---|---|
| Fructose | <0.25% |
| Glucose | <0.25% |
| Lactose | <0.25% |
| Maltose | <0.25% |
| Sucrose | 93.16% |
| Total sugars | 93.82% |
| Ash | 2.265% |
| Calcium | 0.472 mg/100 g |
| Carbohydrates | 94.72% |
| Iron | 1.2 mg/100 g |
| Moisture | 1.18% |
| Protein | 1.42% |
| Sodium | 7.17 mg/100 g |
| Total Dietary Fiber | 0.9% |
| Total Fat | 0.424% |
| Vitamin A (Beta Carotene) | <100 IU/100 g |
| Vitamin C | <0.5 mg/100 g |
| Calories | 388 cal/100 g |

Once mixing is complete, a valve on the mixing tank (107,108, 109) is opened and the mixed slurry is dispensed into the in-line molding equipment, such as a “Vita-line” (110) from Gram Equipment, Inc., New Jersey, and the freezing process is begun. At this step in the process, the mold cavity and accessories (111, 112) which are received and stored in warehouse are sent to the end of the Vita-line (110) for filling so that freezing can occur in the proper mold cavities prior to final packaging and labeling. Wrapping and boxing (113) is performed next, followed by a quality control section utilizing a “safeline” metal detector (114), such as those manufactured by Mettler-Toledo, to ensure no foreign metal objects are trapped in the final packaged products.

Subsequent to full quality inspection, the ice lollys are packed into master cases (115), which must be dated and coded and sealed (116). The cases are then palletized and labeled as “organic” (117) prior to being placed in a deep freezer (118) set for or below −23 degrees Centigrade. Ice lollys are then shipped (119) by truck, rail or air to the appropriate distribution wholesale or retail facilities.

The present invention preferably comes in at least nine flavor compositions, including; Berries 'N Cherries, Dark Chocolate Mint, Mango, Southern Ice Tea, and Toasted Coconut. Each flavored composition comprises a unique tea based ingredient profile and is formulated with a variety of the fruits and/or vegetables which must also be USDA certified organic, non-GMO and kosher graded.

Tables 1-9 below indicate an exemplary ingredient profile, formulation, and nutritional facts panel for each of the aforementioned and additional flavors according to at least one embodiment of the present invention:

TABLE 1
Berries N′ Cherries

| Ingredients | % | kg |
|---|---|---|
| Filtered water, (Liters = kg at room | 60.0855% | 2693.398 |
| temperature) | | |
| FTO Rooibos Tea Extract Powder | 0.0783% | 3.509 |
| FTO White Tea Distillate | 0.2642% | 11.843 |
| Organic Vanilla Extract 2 fold | 0.1957% | 8.772 |
| Organic Cherry Juice Concentrate 68 BRIX | 7.1135% | 318.871 |
| Organic Strawberry Puree | 14.5662% | 652.947 |
| Organic Blueberry Juice Concentrate, | 1.5438% | 69.204 |
| 65°Brix, frozen | | |
| Organic Blueberry Puree | 6.5708% | 294.542 |
| Organic Guar Gum 6068 | 0.1566% | 7.018 |
| Organic Dehydrated Coconut Flower | 9.4255% | 422.509 |
| Blossom Nectar | | |
| TOTAL | 100.0000% | 4482.612 |

NUTRITION INFORMATION
Nutrition Facts

| | |
|---|---|
| Serving Size 1 bar (52 g) | |
| Servings Per Container | |
| Amount per Serving | |
| Calories 30 | Calories from Fat 0 |
| % Daily Value* | |
| Total Fat 0 g | 0% |
| Saturated Fat 0 g | 0% |
| Trans Fat 0 g | |
| Cholesterol 0 mg | 0% |
| Sodium 0 mg | 0% |
| Total Carbohydrates | 2% |
| 7 g | |
| Dietary Fiber 0 g | 0% |
| Sugars 6 g | |
| Protein 0 g | |
| Vitamin A 0%* | Vitamin C 4% |
| Calcium 0%* | Iron 2% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |
| Total Carb | 300 | g | 375 g |
| Dietary Fiber | 25 | g | 30 g |

TABLE 2
Tropical Mango

| Ingredients | % | kg |
|---|---|---|
| Filtered water, (Liters/kg at room temperature) | 66.470% | 2979.586 |
| FTO Rooibos Tea Extract Powder | 0.206% | 9.216 |
| Organic Vanilla Extract 2 fold | 0.3855% | 17.280 |
| Organic Mango Puree | 20.0082% | 896.889 |
| Organic Pineapple Juice Concentrate | 2.6535% | 118.947 |
| Organic Guar Gum 6068 (Food Specialties) | 0.2079% | 9.320 |
| Organic Dehydrated Coconut Flower Blossom | 10.0181% | 449.072 |
| Nectar | | |
| Organic Citric Acid | 0.0514% | 2.304 |
| TOTAL | 100.000% | 4482.615 |

NUTRITION INFORMATION
Nutrition Facts

| | |
|---|---|
| Serving Size 1 bar (52 g) | |
| Servings Per Container | |
| Amount per Serving | |
| Calories 25 | Calories from Fat 0 |
| | % Daily Value* |
| Total Fat 0 g | 0% |
| Saturated Fat 0 g | 0% |
| Trans Fat 0 g | |
| Cholesterol 0 mg | 0% |
| Sodium 0 mg | 0% |
| Total Carbohydrates | 2% |
| 7 g | |
| Dietary Fiber 0 g | 0% |
| Sugars 6 g | |
| Protein 0 g | |
| Vitamin A 8%* | Vitamin C 6% |
| Calcium 0%* | Iron 0% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |
| Total | 300 | g | 375 g |
| Carbohydrate | | | |
| Dietary Fiber | 25 | g | 30 g |

TABLE 3
Southern Iced Tea

| Ingredients | % | kg |
|---|---|---|
| Filtered water, (Liters/kg at room temperature) | 47.881% | 2146.325 |
| Organic Black Tea Concentrate | 40.106% | 1797.796 |
| Organic Guar Gum | 0.2980% | 13.358 |
| Organic Lemon Juice, Concentrate | 0.2119% | 9.497 |
| Organic Lemon Essence (primal essence) | 0.0092% | 0.412 |
| Organic Liquid Honey | 11.4943% | 515.243 |
| TOTAL | 100.000% | 4482.631 |

NUTRITION INFORMATION
Nutrition Facts

| | |
|---|---|
| Serving Size 1 bar (52 g) | |
| Servings Per Container | |
| Amount per Serving | |
| Calories 20 | Calories from Fat 0 |
| | % Daily Value* |
| Total Fat 0 g | 0% |
| Saturated Fat 0 g | 0% |
| Trans Fat 0 g | |
| Cholesterol 0 mg | 0% |
| Sodium 0 mg | 0% |
| Total Carbohydrates 5 g | 2% |
| Dietary Fiber 0 g | 0% |
| Sugars 5 g | |
| Protein 0 g | |
| Vitamin A 0%* | Vitamin C 0% |
| Calcium 0%* | Iron 0% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |

| | |
|---|---|
| Total | 300-325 g |
| Carbohydrate | |
| Dietary Fiber | 25-30 g |

TABLE 4
Toasted Coconut

| Ingredients | % | kg |
|---|---|---|
| Filtered water, (Liters/kg at room temperature) | 48.781% | 2186.644 |
| Rooibos Tea Extract Powder | 0.1005% | 4.507 |
| Organic Coconut Cream | 39.1059% | 1752.965 |
| Organic Guar Gum 6068 | 0.2980% | 13.358 |
| Organic Dehydrated Coconut Flower Blossom | 11.4943% | 515.243 |
| Nectar | | |
| Organic Pineapple Juice Concentrate | 0.2209% | 9.900 |
| TOTAL | 100.000% | 4482.617 |

NUTRITION INFORMATION
Nutrition Facts

| | |
|---|---|
| Serving Size 1 bar (52 g) | |
| Servings Per Container | |
| Amount per Serving | |
| Calories 70 | Calories from Fat |
| | 40 |
| | % Daily Value* |
| Total Fat 5 g | 8% |
| Saturated Fat 5 g | 25% |
| Trans Fat 0 g | |
| Cholesterol 0 mg | 0% |
| Sodium 25 mg | 1% |
| Total Carbohydrates | 2% |
| 7 g | |
| Dietary Fiber 0 g | 0% |
| Sugars 6 g | |
| Protein 0 g | |
| Vitamin A 0%* | Vitamin C 2% |
| Calcium 0%* | Iron 2% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |
| Total | 300 | g | 375 g |
| Carbohydrate | | | |
| Dietary Fiber | 25 | g | 30 g |

TABLE 5
Dark Chocolate Mint

| Ingredients | % | kg |
|---|---|---|
| Filtered water, (Liters/kg at room temperature) | 88.620% | 1986.246 |
| Rooibos Tea Extract Powder | 0.185% | 4.147 |
| Organic Peppermint Tea Essence | 0.0496% | 1.111 |
| Organic Dehydrated Coconut Flower Blossom | 10.3675% | 232.367 |
| Nectar | | |
| Organic Vanilla Extract 2 fold | 0.0835% | 1.871 |
| Organic Guar Gum 6068 | 0.2949% | 6.609 |
| Organic Cocoa Distillate | 0.4000% | 8.965 |
| TOTAL | 100.000% | 2241.3161 |

TABLE 6
Raspberry Chamomile Cream

| Ingredients | % | kg |
|---|---|---|
| Filtered water, (Liters/kg at room temperature) | 68.948% | 7.317 |
| Chamomile Essence (Primal Essence) | 0.101% | 0.011 |
| Raspberry Juice concentrate | 1.0157% | 0.108 |
| Organic Vanilla Extract 2 fold | 0.1889% | 0.020 |
| Organic Coconut Cream ITI TROPICALS | 16.2214% | 1.721 |
| Organic Guar Gum 6068 (Food Specialties) | 0.2199% | 0.023 |
| Organic Dehydrated Coconut Flower Blossom | 9.4439% | 1.002 |
| Nectar | | |
| Organic Coconut Water Powder | 1.663% | 0.176 |
| Raspberry Puree | 2.1986% | 0.233 |
| TOTAL | 100.000% | 10.612 |

TABLE 7
Hibiscus Lemonade

| Ingredients | % | kg |
|---|---|---|
| Filtered water, (Liters/kg at room temperature) | 84.701% | 8.995 |
| HIBISCUS CONCENTRATE | 1.166% | 0.117 |
| Organic Guar Gum | 0.2980% | 0.032 |
| Organic Lemon Juice, Concentrate | 0.3119% | 0.033 |
| Organic Lemon Essence (primal essence) | 0.0292% | 0.003 |
| Organic Liquid Honey | 13.4943% | 1.432 |
| TOTAL | 100.000% | 10.612 |

TABLE 8
Raspberry Citrus Green Tea

| Ingredients | % |
|---|---|
| Filtered water, (Liters/kg at room temperature) | 57.730% |
| Organic Raspberry Puree | 29.1059% |
| Organic Dehydrated Coconut Flower Blossom Nectar | 12.4943% |
| Organic Guar Gum | 0.2980% |
| Organic Lemon Juice, Concentrate | 0.2209% |
| FTO Green Tea Concentrate | 0.1005% |
| Organic Lemon Extract (primal essence) | 0.0505% |
| TOTAL | 100.000% |

NUTRITION INFORMATION
Nutrition Facts

| | |
|---|---|
| Serving Size 1 bar (52 g) | |
| Servings Per Container | |
| Amount per Serving | |
| Calories 30 | Calories from Fat 0 |
| | % Daily Value* |
| Total Fat 0 g | 0% |
| Saturated Fat 0 g | 0% |
| Trans Fat 0 g | |
| Cholesterol 0 mg | 0% |
| Sodium 4 mg | 0% |
| Total Carbohydrates 8 g | 3% |
| Dietary Fiber less than 1 gram | 0% |
| Sugars 7 g | |
| Protein 0 g | |
| Vitamin A 0%* | Vitamin C 4% |
| Calcium 0%* | Iron 2% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |
| Total | 300 | g | 375 g |
| Carbohydrate | | | |
| Dietary Fiber | 25 | g | 30 g |

TABLE 9
Raspberry Coconut Tea

| Ingredients | % |
|---|---|
| Filtered water, (Litres/kg at room temperature) | 46.281% |
| FTO Hibiscus Extract | 0.5005% |
| Organic Coconut Cream | 29.1059% |
| Organic Guar Gum | 0.2980% |
| Organic Dehydrated Coconut Flower Blossom Nectar | 11.4943% |
| Chamomile Extract | 0.100% |
| Raspberry Puree | 12.2209% |
| TOTAL | 100.000% |

Nutrition Facts

| | |
|---|---|
| Serving Size 1 bar (52 g) | |
| Servings Per Container 1 | |
| Amount per Serving | |
| Calories 40 | Calories from Fat 20 |
| | % Daily Value* |
| Total Fat 2 g | 3% |
| Saturated Fat 0 g | 0% |
| Trans Fat 0 g | |
| Cholesterol 0 mg | 0% |
| Sodium 10 mg | 0% |
| Total Carbohydrates 6 g | 2% |
| Dietary Fiber 0 g | 0% |
| Sugars 6 g | |
| Protein 0 g | |
| Vitamin A 0%* | Vitamin C 2% |
| Calcium 0%* | Iron 2% |

*Percent Daily Values are based on a 2,000 calorie diet. Your Daily
Values may be higher or lower depending on your calorie needs.

| Calories: | 2,000 | | 2,500 |
|---|---|---|---|
| Total Fat | Less than 65 | g | 80 g |
| Sat Fat | Less than 20 | g | 25 g |
| Cholesterol | Less than 300 | mg | 300 mg |
| Sodium | Less than 2,400 | mg | 2,400 mg |
| Total Carbohydrate | 300 | g | 375 g |
| Dietary Fiber | 25 | g | 30 g |

In a preferred embodiment, the final equilibrium pH of the at least nine flavors will not be greater than 7.00. Given the formulations and maximum equilibrium pH, each formulation is processed at or below 4 degrees Centigrade within 10 minutes or equivalent.

The packaging preserves product integrity from factory to shelf, allowing the product to be sold shelf stable and delivered as a freeze and eat product, thereby providing convenience to the consumer. The packaging is also bisphenol A (BPA) free.

A number of embodiments of the invention have been described. Nevertheless, it will be understood that various modifications may be made without departing from the spirit and scope of the invention. Accordingly, other embodiments are contemplated within the scope of the following claims.

We claim:

1. A frozen liquid tea based composition comprising: water, non-genetically modified organism (non-GMO) grown tea powder and/or tea concentrate, methyl glucoside coconut oil ester, guar, gellan or pectin gum, and USDA certified organic non-genetically modified organism (non-GMO) grown fruit or vegetables in the form of a concentrate of liquid, puree, or powder.

2. The frozen liquid composition of claim 1, wherein said tea is USDA certified organic non-GMO instant tea in that said tea has been previously steeped and dried and powdered prior to rehydration.

3. The frozen liquid composition of claim 1, wherein said tea is a USDA certified organic black non-GMO tea concentrate in that said concentrated black tea is tea that has been steeped such that at least 80% of the water used for steeping is removed either during or after being steeped.

4. The frozen liquid composition of claim3, wherein said tea is Coopers Tea which is concentrated in a form such that a ratio of 5:1 parts water to concentrated tea forms a mixture of tea that is consumable and palatable to the consumer.

5. The frozen liquid composition of claim 2, wherein said instant tea is a powdered extract form of rooibos tea, the leaves of which are obtained from the aspalathus linearis bush plant grown primarily in South America.

6. The frozen liquid composition of claim 2, wherein said tea is a peppermint tea essence.

7. The frozen liquid composition of claim 2, wherein said tea is a white tea distillate.

8. The frozen liquid composition of claim 1, wherein fruits or vegetables in the form of powders, purees, or concentrates comprise one or more of the following USDA certified organic, non-genetically modified organism (GMO) based ingredients: apple puree, blueberry juice concentrate, blueberry puree, cherry concentrate, coconut cream, coconut water powder, dehydrated coconut flower blossom nectar, guar gum, lemon juice concentrate, liquid honey, mango puree, peach juice concentrate, pineapple juice concentrate, strawberry puree, vanilla extract, lemon essence, citric acid, and cocoa distillate.

9. The liquid composition of claim 4, wherein the natural flavor comprises one or more of the following ingredients: blood orange flavor, lemon flavor extract, chocolate flavor, vanilla extract, green tea flavor, and blueberry flavor.

10. The methyl glucoside coconut oil ester of claim 1, wherein said ester is obtained from the fresh sap of coconut tree inflorescence and said sap is evaporated until it turns into fine granules.

11. A method of forming a frozen liquid composition, wherein said composition is water, tea powder or tea concentrate, methyl glucoside coconut oil ester, guar, gellan or pectin gum, and USDA certified organic non-genetically modified organism (GMO) grown fruit or vegetables in the form of a concentrate of liquid, puree, or powder comprising the steps of:
mixing the ingredients of said composition into a homogeneous mixture within a mixing device kept at or below 4 degrees Centigrade thereby keeping said mixture at or below 4 degrees Centigrade while filling and mixing said mixture into a container;
(ii) removing said mixture from said container after said mixture is homogeneous;
(iii) filling a cavity with said mixture while maintaining said mixture at or below 4 degrees Centigrade;
(iv) continuously cooling said mixture and;
(v) freezing said mixture within said cavity.

12. A process for making a frozen liquid tea based composition comprising: water, non-genetically modified organism (non-GMO) grown tea powder or tea concentrate, methyl glucoside coconut oil ester, guar, gellan or pectin gum, and USDA certified organic non-genetically modified organism (non-GMO) grown fruit or vegetables in the form of a concentrate of liquid, puree, or powder, wherein said process includes preparing, mixing, and filling said composition into a ice lolly cavity at or below 4 degrees Centigrade.

13. The process of claim 11, wherein said tea is USDA certified organic non-GMO instant tea in that said tea has been previously steeped and dried and powdered prior to rehydration.

14. The process of claim 11, wherein said tea is a USDA certified organic non-GMO black tea concentrate in that said concentrated black tea is tea that has been steeped such that at least 80% of the water used for steeping is removed either during or after being steeped.

15. The process of claim 14, wherein said tea is Coopers Tea which is concentrated in a form such that a ratio of 5:1 parts water to concentrated tea forms a mixture of tea that is consumable and palatable to the consumer.

16. The process of claim 13, wherein said instant tea is a powdered extract form of rooibos tea, the leaves of which are obtained from the aspalathus linearis bush plant grown primarily in South America.

17. The process of claim 13, wherein said tea is a peppermint tea essence.

18. The process of claim 13, wherein said tea is a white tea distillate.

19. The process of claim 13, wherein fruits or vegetable in the form of powders, purees, or concentrates comprises one or more of the following USDA certified organic, non-genetically modified organism (GMO), kosher certified ingredients: apple puree, blueberry juice concentrate, blueberry puree, cherry concentrate, coconut cream, coconut water powder, dehydrated coconut flower blossom nectar, guar gum, lemon juice concentrate, liquid honey, mango puree, peach juice concentrate, pineapple juice concentrate, strawberry puree, vanilla extract, lemon essence, citric acid, and cocoa distillate.

20. The process of claim 12, wherein said methyl glucoside coconut oil ester is obtained from the fresh sap of coconut tree inflorescence and said sap is evaporated until it turns into fine granules.
